(19) United States
(12) Patent Application Publication
(10) Pub. No.: US 2010/0068947 A1
(43) Pub. Date: Mar. 18, 2010

(54) CONTACT TERMINAL FOR BURN-IN-TEST-SOCKET

(75) Inventors: SHIH-WEI HSIAO, Tu-Cheng (TW); WEN-YI HSIEH, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/561,215

(22) Filed: Sep. 16, 2009

(30) Foreign Application Priority Data
Sep. 16, 2008 (TW) 97216698

(51) Int. Cl. H01R 4/48

(52) U.S. Cl. 439/786

(57) ABSTRACT

A contact assembly includes a first contact, a second contact and a coil spring enclosing the first and the second contacts. The first contact has a first contacting section and a first mating section. The first mating section includes a pair of sliding arms. The second contact has a second contacting section and a second mating section. The second mating section has pair of protrusions at a top end thereof, the protrusions defines a pair of guiding slots to guiding the sliding arms to contact with the second mating section.

### BACKGROUND OF THE INVENTION

1. Field of the Invention

The present invention relates to a contact terminal set, and more particularly to a contact terminal set configured with an upper and lower contact parts slidably interconnected with each other and incorporated with a stop preventing over-extension between the two.

2. Description of Related Art

U.S. Pat. No. 7,025,602 issued to Hwang on Apr. 11, 2006 discloses a contact assembly for interconnecting an IC (Integrated Circuit) package to a PCB (Printed Circuit Board). The contact assembly includes an upper contact and a lower contact slidably interconnected with each other. A coil spring is arranged between the two such that the upper and lower contacts are repelling axially from each other. Each of the contacts has a pair of hooks formed at a free end thereof and opposite to each other, and an opening located substantially at a middle position thereof. The hooks of one contact are engaged with the opening of the other contact so as to limit the movement of the contacts.

However, the opening is designed in a mating portion of the contact which results high impedance of the contact. In addition, it is difficult to manufacture the hooks of the contact to ensure the hooks stopped by the opening reliably.

In view of the above, an improved contact assembly of low impedance and high reliability is needed.

### SUMMARY OF THE INVENTION

Accordingly, an object of the present invention is to provide a contact assembly of low impedance and high reliability.

According to one aspect of the present invention, there is provided a contact assembly which includes a first contact, a second contact and a coil spring enclosing the first and the second contacts. The first contact has a first contacting section and a first mating section. The first mating section includes a pair of sliding arms. The second contact has a second contacting section and a second mating section. The second mating section has pair of protrusions at a top end thereof, the protrusions defines a pair of guiding slots to guiding the sliding arms to contact with the second mating section.

Other objects, advantages and novel features of the invention will become more apparent from the following detailed description when taken in conjunction with the accompanying drawings, in which:

### BRIEF DESCRIPTION OF THE DRAWINGS

FIG. 1 is an assembled, perspective view of a contact assembly in accordance with a preferred embodiment of the present invention;

FIG. 2 is an exploded, perspective view of the contact assembly shown in FIG. 1;

FIG. 3 is an assembled, perspective view of the contact assembly showing a first contact and a second contact, but not a coil spring;

FIG. 4 is a front view of FIG. 3; and

FIG. 5 is a side view of FIG. 3.

### DETAILED DESCRIPTION OF THE INVENTION

Reference will now be made to the drawings to describe the present invention in detail.

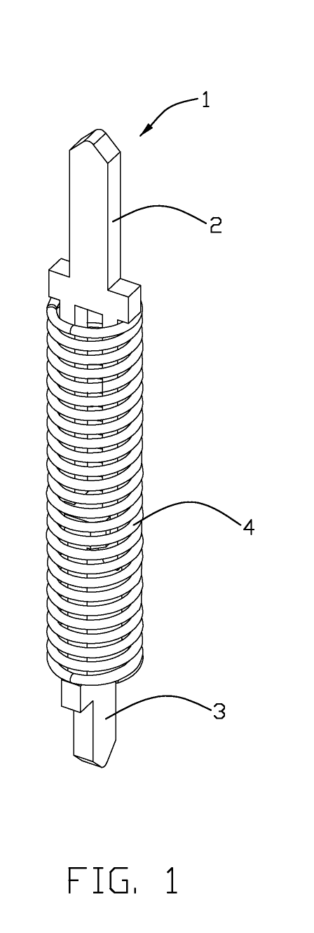

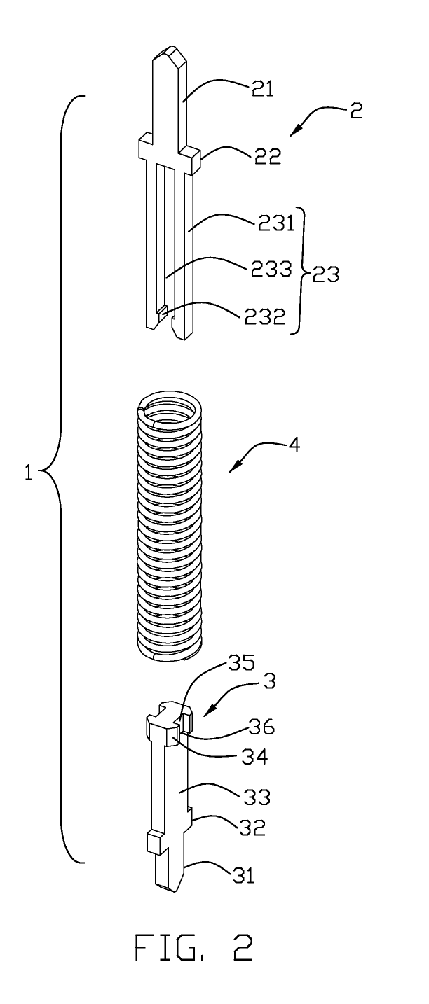

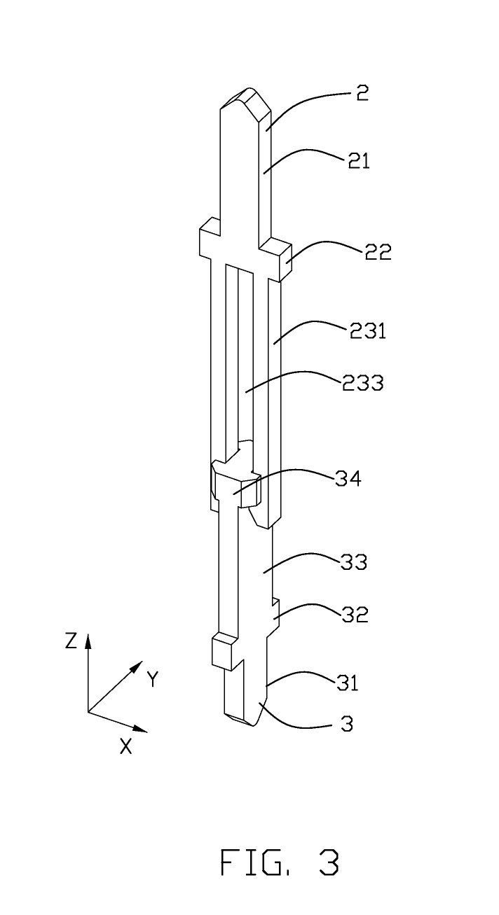

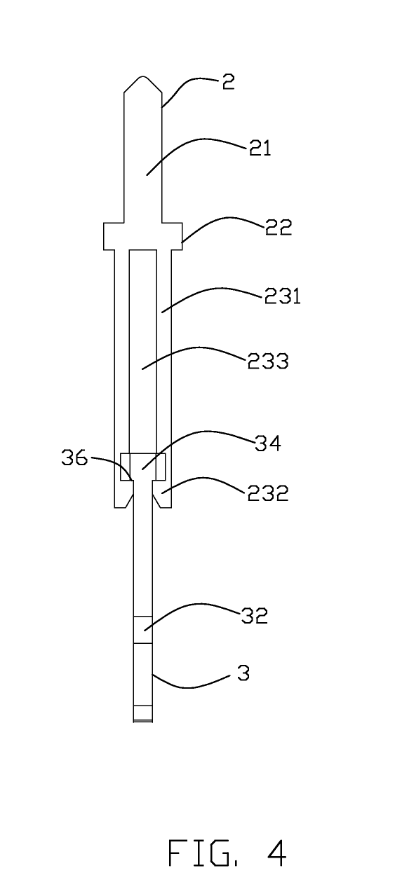

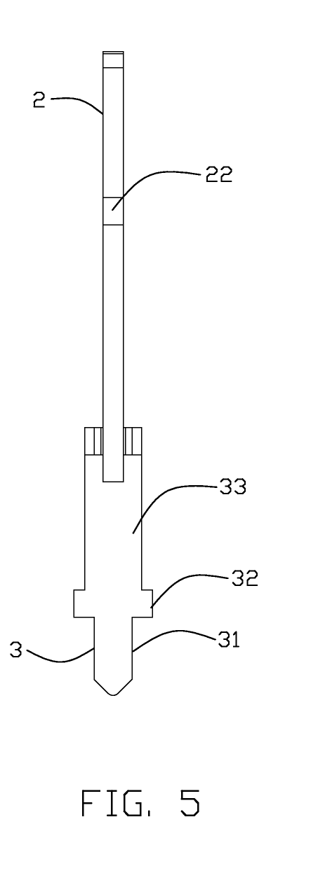

FIGS. 1-5 illustrate a contact assembly 1 in accordance to a preferred embodiment of the present invention, which is generally used in a connector (not shown) for testing an IC package (not shown) to a PCB (not shown).

The contact assembly 1 includes a first contact 2 and a second contact 3 mated with each other, and a coil spring 4 enclosing the first and second contacts 2, 3 so as to provide an elastic force for repelling the contacts 2, 3 away from each other.

The first contact 2 has a first contacting section 21 for contacting with the IC package, a mating section 23, and a first shoulder 22 located between the first contacting section 21 and the first mating section 23. Similarly, the second contact 3 has a second contacting section 31 for contacting with the PCB, a second mating section 33, and a second shoulder 32 located between the second contacting section 31 and the second mating section 33. The first and the second mating sections 23, 33 interlock with each other so as to establish electrical connection therebetween. The first and the second shoulders 22, 32 jointly serve for positioning the coil spring 4 and preventing the coil spring 4 from escaping away from the contacts 2, 3. The coil spring 4 is enveloped onto the second mating section 33 and sliding arms 231, and compressed by the first and second shoulders 22, 32.

The first mating section 23 of the first contact 2 includes a pair of sliding arms 231 parallel to each other with a receiving slot 233 formed therebetween. The free ends of the two sliding arms 231 are respectively provided with a hook 232 extends toward each other so as to jointly clasp the second mating section 33 of the second contact 3. The second mating section 33 of the second contact 3 has a solid planar body without any opening or the like formed therein. Cross section of the solid planar body serves as a signal transmitting path thereby ensuring low impedance of the contact 3.

In addition, the top end of the second mating section 33 is provided with two protrusions 34 at opposite sides with a guiding slot 35 defined therebetween. The protrusions 34 extend beyond the planar body and thus are able to limit the movement of the sliding arm 231 of the first contact 2. A stepping portion 36 is formed in the guiding slot 35 to offset with the planar body of the second mating section 33 in the direction thereof so that the hooks 232 of the first contact 2 are able to engage with the stepping portion 36 to prevent separation of the two contacts 2, 3. The sliding arms 231 slides in one guiding slot 35 respectively with the second mating section 33 of the second contact 3 moving within the receiving slot 233 of the first contact 3. During the movement of first contact 2 and the second contact 3, the hooks 232 of the first contact 2 reliably keep contacting with the planar body of the second contact 3 so that the risk of disconnection is avoided.

When the connector employs a plurality of the contact assemblies 1 of the present invention and is mounted on a PCB with the IC package thereon, the first and the second contacts 2, 3 jointly compress the coil spring 4 disposed therebetween. When the IC package is removed, the contact assembly 1 is released and the coil spring 4 drives the first and the second contacts 2, 3 to move away from each other.

While the preferred embodiments in accordance with the present invention has been shown and described, equivalent modifications and changes known to persons skilled in the art according to the spirit of the present invention are considered within the scope of the present invention as defined in the appended claims.

What is claimed is:

1. A contact assembly comprising:
a first contact having a first contacting section and a first mating section, the first mating section comprising a pair of sliding arms;
a second contact having a second contacting section and a second mating section, the second mating section having a pair of protrusions at a top end thereof, said protrusions defining a pair of guiding slots to guiding the sliding arms contacting with the second mating section; and
a coil spring enclosing the first and the second contacts.

2. The contact assembly as claimed in claim 1, wherein the sliding arms of the first contact are respectively formed with a hook, wherein the second contact has a stepping portion offsetting with the planar body in the direction thereof so that the hooks of the first contact are able to engage with the stepping portion to prevent the excessively and upwardly sliding of the first contact.

3. The contact assembly as claimed in claim 2, wherein the first contact and second contact are substantially planar plate and the first contact is perpendicular to the second contact.

4. The contact assembly as claimed in claim 3, wherein the first and second contact are more relative to each other in an up to down direction.

5. The contact assembly as claimed in claim 1, wherein the first and the second contacts each has a shoulder engaging with the coil spring and preventing the coil spring from escaping away from the contact assembly.

6. The contact assembly as claimed in claim 5, wherein the shoulder is located between the contacting section and the mating section of the first and second contact.

7. A contact assembly, comprising:
a first contact having a first contacting section and a first mating section, the first mating section comprising a pair of sliding arms in a vertical direction;
a second contact having a second contacting section and a second mating section, the second mating section having a substantially planar body engaging with the sliding arms of the first contact, and at least one pair of protrusions extending beyond the planar body and capable of limiting the movement of the sliding arm in vertical direction; and
a coil spring enclosing the first and the second contacts.

8. The contact assembly as claimed in claim 7, wherein the protrusions define a pair of guiding slots therebetween, in which the sliding arm of the first contact moves.

9. The contact assembly as claimed in claim 8, wherein the sliding arms are respectively formed with a hook, wherein the second contact has a stepping portion offsetting with the planar body in the direction thereof so that the hooks of the first contact are able to engage with the stepping portion to prevent the excessively and upwardly sliding of the first contact.

10. The contact assembly as claimed in claim 9, wherein the first contact and second contact are substantially planar plate and the first contact is perpendicular to the second contact.

11. The contact assembly as claimed in claim 10, wherein the first and second contact are more relative to each other in an up to down direction.

12. The contact assembly as claimed in claim 7, wherein the first and the second contacts each has an shoulder engaging with the coil spring and preventing the coil spring from escaping away from the contact assembly.

13. The contact assembly as claimed in claim 12, wherein the shoulder is located between the contacting section and the mating section of the first and second contact.

14. A contact terminal set, comprising:
a first part having a base portion with a pair of contact arms extending therefrom;
a second part slidably engaged with the contact arms with surfaces thereon, and including a step preventing the contact arms from escaping therefrom; and
a coil spring enclosing the first and second parts driving the first and second parts away from each other.
